(19) United States
(12) Patent Application Publication
(10) Pub. No.: US 2016/0132275 A1
(43) Pub. Date: May 12, 2016

(54) Methods and Systems for Enhancement of Game Creativity

(71) Applicant: Robert Mackowiak, Pawtucket, RI (US)

(72) Inventor: Robert Mackowiak, Pawtucket, RI (US)

(21) Appl. No.: 14/875,073

(22) Filed: Oct. 5, 2015

Related U.S. Application Data
(60) Provisional application No. 62/059,291, filed on Oct. 3, 2014.

(51) Int. Cl. G06F 3/12

(52) U.S. Cl. CPC G06F 3/1237

(57) ABSTRACT

Disclosed herein are methods and systems for enhancing creativity in an interactive online environment through a system. The disclosed systems comprise 3D printers, computers, and interfaces between the computers and the printers. In addition, the disclosed methods and systems allow for creating one or more digital objects and generating one or more digital representations of the one or more three-dimensional objects; in addition, redistribution of digital representations can be performed in the digital environment.

### FIELD OF THE INVENTION

The technology herein relates generally to game systems for playing video and/or computer games as well as 3D printer machines.

### BACKGROUND

Video and computer game systems are well-known in the art and have experienced rapid development over the last three decades. These game systems can include a game machine housing, processing unit, associated hardware, and a display for displaying images of the game. See, e.g., Xbox 360, Playstation, and Nintendo Wii. The gaming program is usually contained on a disk or in memory available on the system. See id.

Three-dimensional (3D) printers—also known as “additive manufacturing”—were first developed in the 1980's. See Jon Excell and Stuart Nathan. The Rise of Additive Manufacturing. The Engineer, dated May 24, 2010. The earliest 3D printers were extremely expensive and used by a select few groups. See Jane Bird. Exploring the 3D Printing Opportunity. The Financial Times, dated Aug. 8, 2012. These early 3D printers were used in product development, prototyping, data visualization, manufacturing, modeling, and industrial engineering.

3D printers work in a variety of ways and with a variety of materials to “grow” parts by solidifying material in layers, typically through “microscoping,” to create a physical model of a 3D file from such programs as Solidworks, Rhinoceros, and ZBrush.

It is possible that the 3D models that exist in the digital realm of the videogame system can be converted to 3D models that can be grown into reality via the 3D printer. This also allows opportunity for the user to edit and create their own files for use within the game, opening up a nearly infinite realm of opportunities for creative game players, whether they are creating new weapons for a game such as Call of Duty or a new wheel for a vehicle in Mario Kart.

As traditional toy sales fail to compete with the growing advancement of videogames and other forms of digital entertainment, both children and adults are sacrificing creativity to become engaged in digital entertainment. Currently, the best selling video games are divided into broad categories of role-playing, strategy, and shooters. Each of these types of games put the user into an interactive arena of play where they control the game and what happens. The course of the game is dependent on their decisions and actions, resulting in an illusion of control and involvement in progression.

Unfortunately, such games do not allow for complete control by the user, limiting the amount of freedom and expression they have within the digital realm; they are not given the right “tools to create.” This does not work in favor of bridging the global creativity gap that details humanity's current lack of and need for more creativity and self-expression. See Adobe. State of Create Study. Adobe Press Release, dated April 2012. In recent surveys, the majority of respondents had favorable views of creativity. For instance, in 2012, two thirds of subjects interviewed across the globe feel that creativity is valuable to society, and forty percent feel that it is essential to have the proper “tools to create.” See Adobe. State of Create Study. Adobe Press Release, dated April 2012. In addition, eighty percent feel that creativity is critical for economic growth. See Adobe. State of Create Study. Adobe Press Release, dated April 2012. Despite these high percentages, only forty percent of these people feel as if they are actually being creative and a mere quarter feel they are living up to their creative potential. See Adobe. State of Create Study. Adobe Press Release, dated April 2012.

The majority of games do not provide the level of freedom and decision-making necessary to allow for a full range of creativity. For these games, while the course of gameplay may change based on various inputs received from the user, the course of the game and the results of actions are generally predefined and are not subject to any manipulation, or editing or variation by the user, other than those predetermined changes that occur based on the various situations encountered during game play. The limited predetermined avenues available for use in most video games restrict the ability of the user to enjoy the game to its fullest creative potential. It may be more enjoyable for the user to have a more interactive relationship with the game program and the game system.

What is needed to encourage creativity and a wholly immersive environment of play, is gaming system linked with a 3D printer that enables the user to both digitally and physically define, manipulate, edit and incorporate aspects of the game being played. This ability would allow the user to pursue an adventure digitally, as in a typical game system, and also physically by harnessing the potential of the 3D printer to create objects imperative to the game. The link between the game system and the 3D printer create a single entity in which both devices communicate with each other to create a fluid interface in which the user's actions and choices affect which objects can and should be created physically and how these printed items continue to interact within the digital world. This allows the user to have a physical representation of their gameplay and their self.

### SUMMARY

The presently disclosed methods and systems relate to allowing a user of a digital game to produce three-dimensional objects, while also giving the user the ability to produce digital copies of such objects in the digital environment. The methods and systems allow the user to generate one or more digital representations of the three-dimensional objects that the user created. Such creative back-and-forth between the digital environment and the real world provides users with enhanced game experience.

In particular, the technology disclosed herein is directed to a game system having the abilities to link and interact with a 3D printer, as well as to manipulate and edit digital aspects of the game in relation with 3D printed objects. In certain embodiments, the disclosed methods and systems incorporate the 3D printed piece into a game that is being played on the game system, and allow the user to transfer data between the two machines, e.g., items within the digital world dependent for progression, that are physically printed in order to proceed.

Aspects of the disclosed methods include enhancing creativity in an interactive online environment through a system. These aspects comprise providing a printer capable of three-dimensional printing, as well as providing a first interface between the printer and a computer system. These aspects also include the computer system comprising a processor and a computer-readable medium that stores instructions in which the processor executes the instructions to perform the steps of accessing an online environment in which a plurality of users interact, receiving data relating to the online environment, communicating data to the three-dimensional printer, wherein the communication includes instructing the three-dimensional printer to perform a function, receiving information from the three-dimensional printer relating to a digital object, and/or sending information from the online environment to the three-dimensional printer; and receiving an input from a user. As used herein, the term “digital object” means a person, shape, animal, or thing created in a virtual or electronic environment that can be stored on an electronic medium and shown on a display. The digital object can be presented as either a two-dimensional representation or a three-dimensional representation.

In certain embodiments, the methods further comprise interacting by way of the computer system with the online environment to distribute information to the environment relating to a particular activity being executed by at least one of the plurality of users and creating one or more digital objects by way of a second interface allowing the user to interact with the computer system. In other embodiments, the methods comprise printing one or more three-dimensional objects, wherein the one or more three-dimensional objects are created from the one or more digital objects, one or more objects obtained from the online environment, or a combination therein. In some embodiments, the methods comprise generating one or more digital representations of the one or more three-dimensional objects, wherein the one or more digital representations can be distributed to the plurality of users within the online environment.

In certain embodiments, the one or more digital objects are stored on the computer-readable medium. In other embodiments, the one or more digital objects are stored as image files.

In particular embodiments, at least one property of the one or more digital objects stored on the computer-readable medium are modified to create one or more secondary digital objects. In more particular embodiments, the one or more digital representations are incorporated into the interactive online environment. In even more particular embodiments, the one or more digital representations comprise metadata. In still more particular embodiments, the metadata comprises information relating to the properties of the one or more digital representations. In yet more particular embodiments, the properties comprise data relating to the origin of the one or more digital representations.

In some embodiments, the interactive online environment is selected from the group consisting of an interactive game, an online chat room, a web conference, a webinar, a blog, and a website.

In certain embodiments, each of the one or more digital objects are identified by a unique digital object identifier. In other embodiments, the methods further comprise using the one or more digital representations in an interactive game. In some embodiments, the methods further comprise using the one or more digital representations in a task required within the interactive online environment.

In certain embodiments, the first interface comprises software.

In particular embodiments, the methods further comprise manipulating (1) the one or more digital representations, (2) one or more digital objects, or a combination of (1) and (2) using the second interface. In more particular embodiments, the one or more digital representations represent one or more avatars. In some embodiments, the one or more digital representations is incorporated into an online game. In yet other embodiments, the one or more digital representations is traded as currency. In still other embodiments, the one or more digital representations is traded as currency within the online game.

In certain embodiments, the methods further comprise generating digital attributes for the one or more digital representations. In some embodiments, the one or more digital attributes is a color. In other embodiments, the one or more digital attributes is a virtual personality. In still other embodiments, the one or more digital attributes is a virtual sound. In further embodiments, the one or more three-dimensional objects comprises a structure that is a replica of (1) one or more digital objects, (2) one or more digital representations, or (3) a combination of (1) and (2).

In certain embodiments, the manipulating comprises altering the appearance of (1) the one or more digital representations or (2) one or more digital objects. In some embodiments, the manipulating comprises providing digital attributes to (1) the one or more digital representations or (2) one or more digital objects. In still more embodiments, the manipulating comprises adding metadata to (1) the one or more digital representations or (2) one or more digital objects.

### BRIEF DESCRIPTION OF THE DRAWINGS

The present exemplary non-limiting implementation will be described in detail herein with reference to the following drawings, in which like reference numerals refer to like elements, and wherein:

FIG. 1 is an external perspective view showing an exemplary structure of a game system, e.g., Xbox 360, Playstation, Wii, or computer, linked with a 3d printer, e.g., Makerbot, Cube, MendleMax, to present exemplary non-limiting implementation;

FIG. 2 is a flow chart describing exemplary functions and communication between game system and 3D printer;

FIG. 3 is a flow chart showing the steps by which the system converts a digital image to a three-dimensional image;

FIG. 4 is flow chart describing exemplary progression and dependent variables in gameplay;

FIG. 5 is a schematic representation of an embodiment of the systems disclosed herein.

### DETAILED DESCRIPTION

Disclosed herein are systems and methods provide for enhancing creativity. In certain embodiments, the disclosed systems and methods enhance activity in an online environment.

Aspects of the disclosed methods comprise providing a printer capable of three-dimensional printing and a first interface between the printer and a computer system. As used herein, the term “providing” includes a user connecting the printer, computer, and interface into a system or one or more suppliers providing the components of the system to a user. The first interface can comprise software and hardware components. In particular embodiments, the first interface comprises a slicer. In other embodiments, the first interface also comprises a hardware interface such as a (USB) interface. In more particular embodiments, the interface/control software allows a user to send a machine code file from the computer to the 3D printer, change some parameters on run time (e.g. speed, flow and temperature), and move the print head manually around the x/y/z axis. In certain embodiments, the disclosed methods utilize computer systems that comprise a processor and a computer-readable medium that stores instructions that the processor executes.

In particular embodiments, the methods comprise accessing an online environment in which a plurality of users interact and/or receiving data relating to the online environment. In other embodiments, the methods comprise communicating data to the three-dimensional printer, wherein the communication includes instructing the three-dimensional printer to perform a function, receiving information from the three-dimensional printer relating to a digital object, and/or sending information from the online environment to the three-dimensional printer.

It should be noted that the one or more digital objects can be used to create one or more 3D objects. In certain embodiments, the one or more 3D objects are used to create one or more digital representations based on the 3D objects. The digital representations can be two-dimensional digital representations of the 3D object or alternatively 3D digital representations of the 3D object.

In other embodiments, the methods comprise receiving an input from a user and/or interacting by way of the computer system with the online environment to distribute information to the environment relating to a particular activity being executed by at least one of the plurality of users. In still other embodiments, one or more digital objects is created by way of a second interface allowing the user to interact with the computer system. The second interface can be a graphical user interface, a web-based user interface, and/or a touchscreen interface. In yet more embodiments, the objects are printed such that the one or more three-dimensional objects are created from: (1) the one or more digital objects, (2) one or more objects obtained from the online environment, or (3) a combination of (1) and (2). In particular embodiments, the user generates one or more digital representations of the one or more three-dimensional objects, wherein the one or more digital representations can be distributed to the plurality of users within the online environment.

Further disclosed herein are systems that allow for the generation of three-dimensional (“3D”) objects from an interactive environment, such as a game environment. In some embodiments, the 3D objects are generated from one or more digital objects. The digital objects can be stored on the computer-readable medium, such as a memory, DVD, CD-ROM, or other memory. The digital objects can be stored as image files including JPEG, TIFF, or other similar files known in the art. The digital objects can also be used to create other digital objects—herein disclosed as “secondary digital objects.” Secondary digital objects can be used to create 3D objects as well.

In certain embodiments, a digital object is incorporated into an interactive online environment. Aspects of the methods disclosed herein can be utilized in an interactive online environment. Interactive online environment includes an interactive game, a chat room, web conferences, webinars, blogs, vlogs, and websites.

In the illustrated embodiment of the product system, there is provided a 3D (three-dimensional) printer, which connects to a pre-existing video game console or computer capable of communicating gameplay information between the two articles, which enhances the interactivity and creativity of a video game.

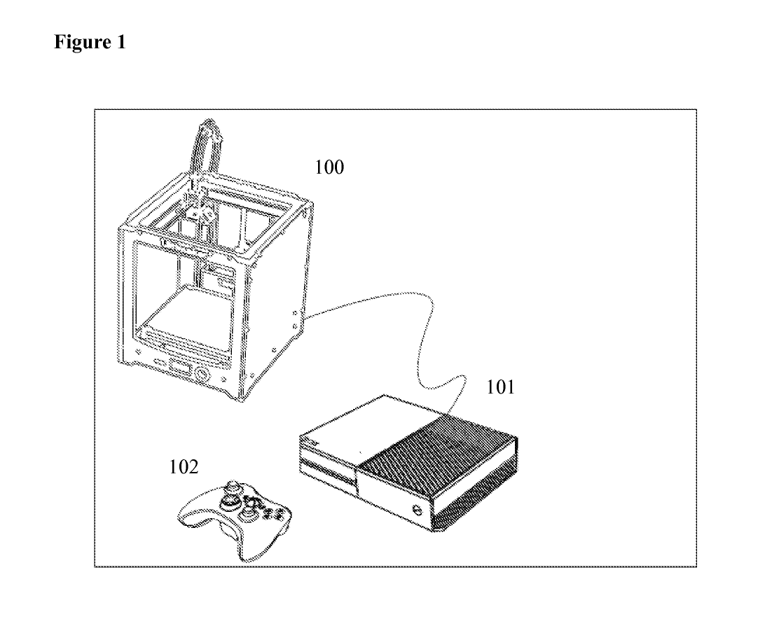

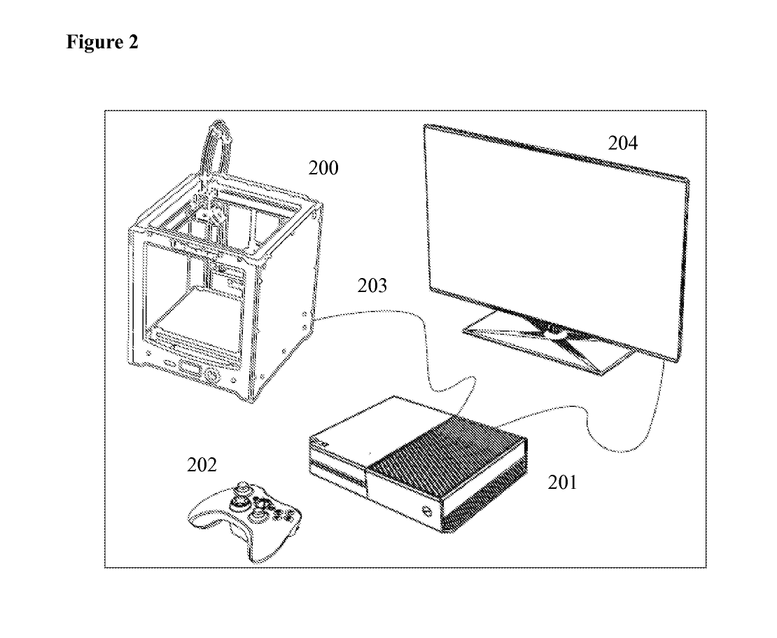

Turning to the figures, there is shown in FIG. 1 a complete system provided for gameplay, comprising of a 3D printer module 100 and videogame system module 101. Connected to the video game system module 101 is the detachable controller 102 and television 204 or monitor as shown in FIG. 2.

FIG. 2 shows a representation in which the video system module 201 is connected to a television or monitor 204. The system module 201 is connected to a detachable controller 202. The 3D printer module 200 and the video game system module 201 are interconnected and can communicate by means of wired connecting housing extensions such as USB cable 203 or by means of wireless connections such as Bluetooth, Ethernet, and other wireless connections.

In use, the 3D printer 100 is connected to a videogame system 101 and a compatible game is inserted into the module 101. Appropriate devices such as a game controller 102 or a keyboard are then used to execute commands within the game and interface. The 3D printer 100 can then be operated during execution of the program and gameplay, either manually or automatically as discussed in more detail below.

The embodiment provides for a video game system enabling print on demand objects. These objects can be utilized for a number of purposes. Firstly, the game can, at predetermined levels, stages of progression, or achievement etc., print out objects integral to the theme of the game. These printable objects are created in cohesion with the game as items necessary for further progression or as rewards for completing portions of the game. These objects have the potential to be personalized by the player to represent him or herself as a physical or digital object. The 3D printer 100 enables the physical creation of the digital object.

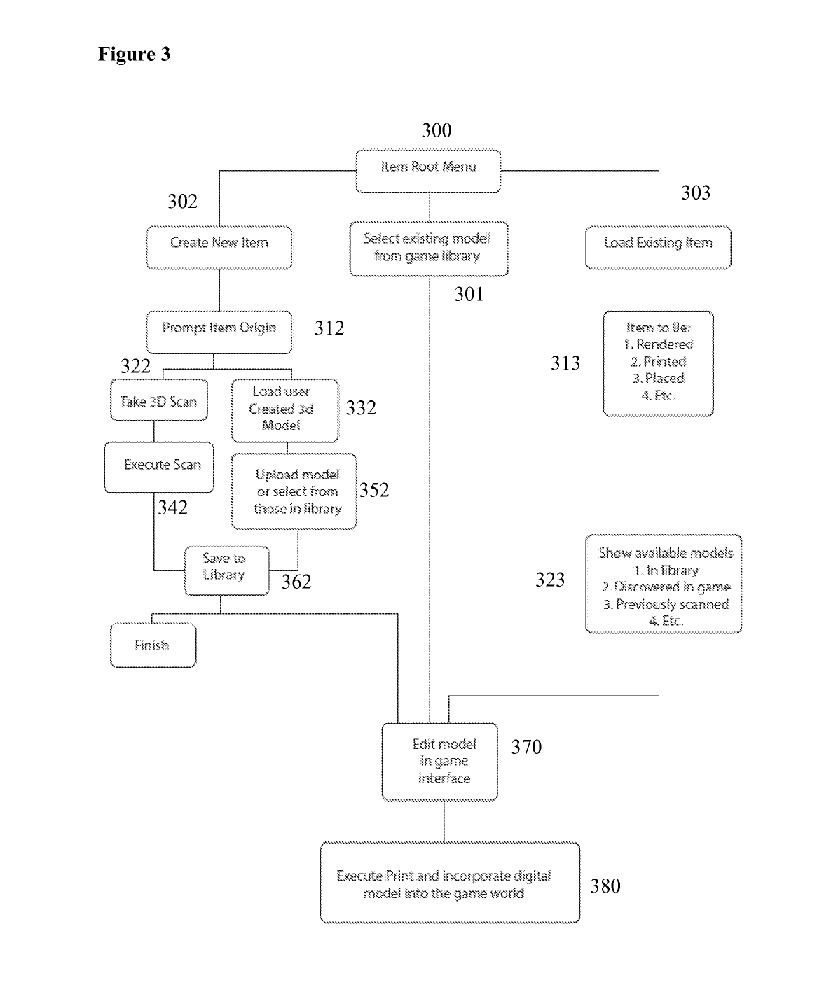

FIG. 3 is a rudimentary example of how the player controls the interface to execute basic commands between the game and the printer. As the player reaches said points within the game where printing physical embodiments of digital game pieces is necessary, selections and modifications are made within the printer interface and executed. The system generates a root menu 300 when the user reaches certain pre-defined points within a game. The user refers to the options in the root menu 300 and chooses an option (e.g., choose digital object from game library 301, create a new item based on game play from system memory 302, load an item obtained during play 303). Other options can be provided to the user depending on the game type. In FIG. 3, if the user chooses to create a new item 302, then the prompts the item origin 312 for the user to load a model from a memory 322 or to scan a 3D model 332. If the user chooses to scan a model, then the user can command a scanner to execute the scan 342. On the other hand, if the user loads a model 322, the system will upload a model to the system or select the model from a database stored in a memory on the system or another computer 352. Once the model is scanned or uploaded, the user can select to save the model into one or more memories 362.

The user can also select the model from a library or database stored in memory on a computer 301. The existing model can have been uploaded or created previously and stored in one or more databases. The existing model can have been modified from other models. The user can also load an existing model from a game, a website, or one or memories 303. In such embodiments, the model can be stored on a computer prior to any manipulation. Once the item (e.g., model) is loaded, the user can have the model rendered, printed on a 3D printer, placed into a game, or manipulated to alter the model 313. The user can also have the loaded models displayed for retrieval or submitted into other games 323. For instance, once a successful print is created, that data is transferred and saved within the videogame and that physical piece will appear as a digital object as well, whether it be within the world or, for example, as an item in a character's inventory. This perpetual linkage between the digital world of the videogame and the physical world of the 3D printer creates, in a sense, a oneness between the two realities.

The user can edit any model using the game interface 370. The size, shape, color, and other features of the model can be modified to match or conform to the game conditions. The user can print 3D objects of the model or incorporate the edited models directly into the game 380. It should be noted that models may be transferred between game worlds and modified to match the conditions in the game world.

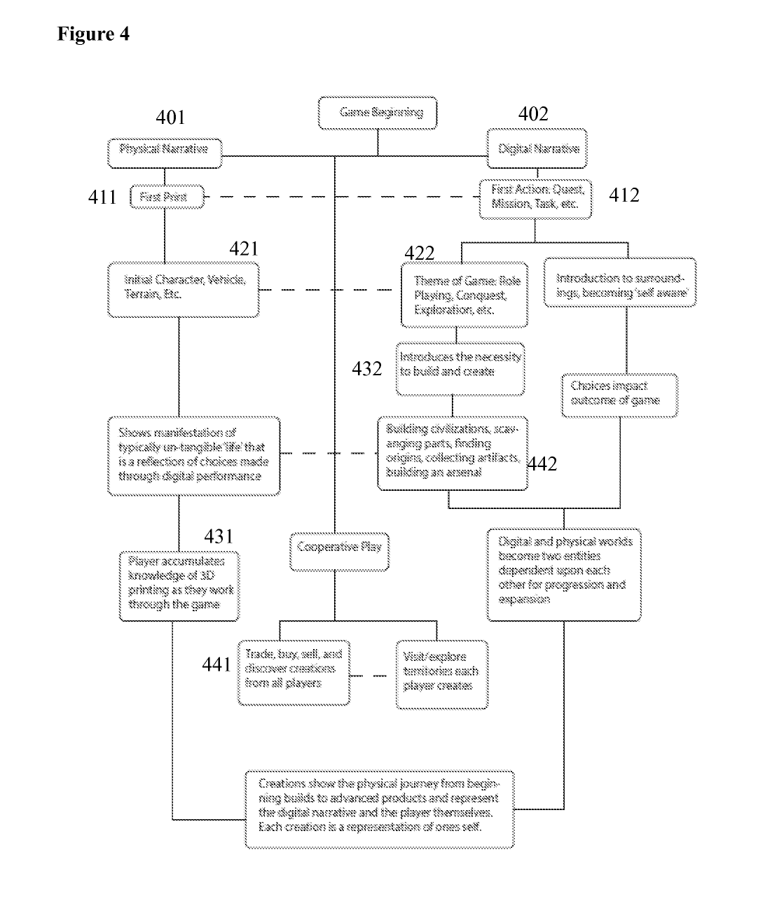

Turning to FIG. 4, a method of playing a game utilizing the disclosed methods and systems is shown. The user can begin a game, which is divided into physical and digital narratives 401 and 402. Upon reaching a point in the game, the user can request that a printer print one of an available object 411. In addition, the first print 411 can be from files stored on a computer. The object can be modified or manipulated. Once modified or manipulated, the object can be scanned and a digital representation of the object placed into the digital narrative 412. The digital object can be used in the theme of the game 422. The game itself has rules that promote building of new and more complex objects to move forward in the game 432. The game can require the building of civilizations, machines, and buildings, as well as weapons 442 for use in the digital narrative 402.

In certain embodiments, the user creates objects for use within the game 421 and scans them for use in the digital narrative 402. The choices by the user in the digital narrative 402 can affect the printing and building in the physical narrative 401 and vice versa.

The disclosed systems and methods further allow the user to develop knowledge relating to the use of 3D printers 431 and to buy, sell, and trade the creations made during game play 441.

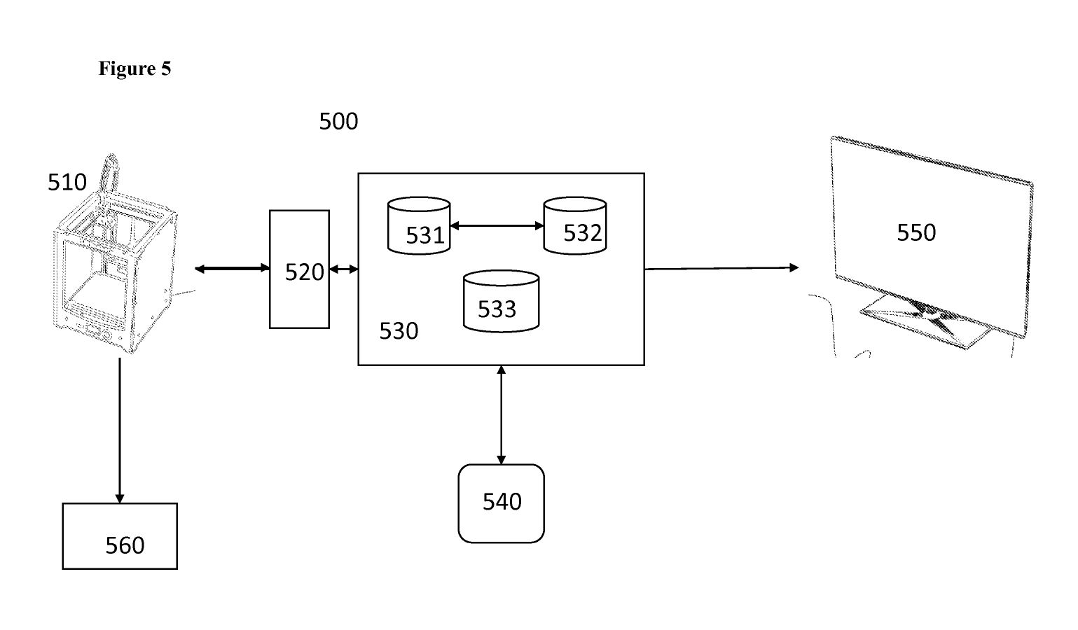

FIG. 5 shows an exemplary embodiment of a system disclosed herein. The system 500 comprises a 3D printer/scanner 510 that allows the user to print 3D objects 560 and scan objects into digital representations. The 3D printer is connected to a computer system 530 through an interface 520. The interface can comprise software and hardware components. In particular embodiments, the interface comprises a slicer. The slicer allows the system to take a drawing and translate (i.e., slice) the drawing into individual layers. In the case of 3D models, the slicer converts the model into a series of planes. The interface then generates code that is sent to the printer. In other embodiments, the interface also comprises a hardware interface such as a (USB) interface. In more particular embodiments, the interface/control software allows a user to send a machine code file from the computer to the 3D printer, change some parameters on run time (e.g. speed, flow and temperature), and move the print head manually around the x/y/z axis. Examples of software that can be used in the first interface include Netfabb engine. The computer system 530 can be a game system, game console, PC, tablet, server, or Smartphone. The computer system 530 comprises a processor 531 and memory 532.

The memory 532 stores instructions that can be executed by the processor 531 to perform particular functions. For instance, the instructions allow for the computer system 530 to access an online environment 540 in which a plurality of users can interact. The instructions also allow the system 530 to receive data relating to the online environment 540. Such data includes game conditions, game instructions, digital images, and digital objects stored on other servers. It should be noted that the system 530 can be connected to the online environment through a wireless network, Ethernet connection, broadband connection, cable connection, or fiber optic connection. The system 530 can also be connected to the online environment 540 by a VPN Furthermore, the system 530 can be connected to one or more servers to allow for information to be transmitted from the online environment 540. In certain embodiments, the instructions allow the system 530 to communicate data to the three-dimensional printer 510. The instructions allow the system 530 to instruct the three-dimensional printer 510 to perform a function such as printing an object, scanning an object. The instructions also allow the system 530 to receive information from the three-dimensional printer 510 relating to a digital object. The instructions also allow the system 530 to send information from the online environment to the three-dimensional printer 510. The instructions also allow the system 530 to receive an input from a user. The system 530 can also send digital images to a monitor or television 550.

The system 530 also can store the digital objects and other digital information on one or more computer-readable media 533. Computer-readable media include DVD, CD-ROM, detachable hard drives, hard disks, flash drives, magnetic disks, and other media capable of storing such information. The computer-readable medium 533 can be located within the system 530 or exterior to the system 530.

A possible additional aspect of the system is the addition of a 3D scanner, as a separate module or as an application on a smartphone as shown in FIG. 5. Given the circumstances, the player can use this scanner to interact further with the game system by importing existing physical objects from the real world into the video game for use in gameplay, and therefore recreating the object via the 3D printer, as necessary for progression in play. For games such as those within the role-playing genre where the player may be prompted to choose, for example, a head for a character, the player may scan their own face to be mapped into the game and subsequently printed out as a physical object when they reach that point of the game.

For players who have an understanding of 3D modeling programs, this game system will provide an interface that allows them to not only print their own personal creations, but also incorporate them into the videogame itself. In such a case where the game prompts the player to choose an item, such as a weapon, for example, the player may choose to select a model they have created separately from the game and subsequently upload this digital model to the game for use as well as print it out as necessary for progression within the game. This freedom of choice encourages players to become knowledgeable in the field of 3D modeling and provides an opportunity to customize their videogame not found in other platforms.

In certain embodiments, the disclosed methods allow for interaction between multiple users on a network. For instance, users on a network can be located in multiple locations around the globe. In the case of gameplay in a global, online environment, players can work with each other to build an open source world in which objects that are scanned or created in modeling programs and then shared with each other. Depending on the type of game, this sharing may include but is not limited to trading, buying or selling, for team use, or hiding objects throughout the world for others to discover and then print. The inverse of this is that the players may use this as an opportunity to this is competitively, or against each other, for example by creating objects that may be useful only to themselves and not others as a way of still encouraging the creation of 3d objects, but in a way that will challenge opponents progression within the game.

The flowchart shown in FIG. 5 illustrates exemplary progression of gameplay in which the player is using a chosen character to navigate and interact with a typical videogame, such as a role playing game, where there is potential for a nearly infinite amount of variables and outcomes based on the players' choices and actions. Within this preferred embodiment of the product system, there are two separate narratives that occur initially; the digital videogame and that of the 3D printer to create objects related to the game. As the player progresses, both physical and digital narratives become intertwined into a cohesive yet complex system of creative and immersive play and interaction.

Where educational software is provided, the illustrated embodiment of the game system can be utilized to guide users, such as students, through an interactive and immersive learning experience with 3d modeling and 3d printing. Such a system provides for an ideal incentive for children and adults alike to become further involved in educational software running on the system. The arrangement can be synergistic between the game playing and educational software, where the educational software is presented in the form of a game in which the player progresses similarly to the course of gameplay presented above. Of course, many other interactive uses can be provided.

It will be appreciated by those skilled in the art that numerous variations and/or modifications may be made to the present invention as shown without departing from the scope of the invention as broadly described. Accordingly, the present embodiment is to be considered in all respects to be illustrative and not restrictive.

1. A method of enhancing creativity in an interactive online environment through a system, the method comprising:
(a) providing a printer capable of three-dimensional printing;
(b) providing an interface between the printer and a computer system; wherein the computer system comprises a processor and a computer-readable medium that stores instructions and the processor executes the instructions to perform the steps of:
(i) accessing an online environment in which a plurality of users interact;
(ii) receiving data relating to the online environment;
(iii) communicating data to the three-dimensional printer, wherein the communication includes instructing the three-dimensional printer to perform a function, receiving information from the three-dimensional printer relating to a digital object, and/or sending information from the online environment to the three-dimensional printer; and
(iv) receiving an input from a user;
(c) interacting by way of the computer system with the online environment to distribute information to the environment relating to a particular activity being executed by at least one of the plurality of users;
(d) creating one or more digital objects;
(e) printing one or more three-dimensional objects, wherein the one or more three-dimensional objects are created from: (1) the one or more digital objects, (2) one or more objects obtained from the online environment, or (3) a combination of (1) and (2); and
(f) generating one or more digital representations of the one or more three-dimensional objects, wherein the one or more digital representations can be distributed to the plurality of users within the online environment.

2. The method of claim 1, wherein the one or more digital objects are stored on the computer-readable medium.

3. The method of claim 2, wherein the one or more digital objects are stored as image files.

4. The method of claim 2, wherein at least one property of the one or more digital objects stored on the computer-readable medium are modified to create one or more secondary digital objects.

5. The method of claim 1, wherein the one or more digital representations are incorporated into the interactive online environment.

6. The method of claim 1, wherein the interactive online environment is selected from the group consisting of an interactive game, an online chat room, a web conference, a webinar, a blog, and a website.

7. The method of claim 1, wherein the one or more digital representations comprise metadata.

8. The method of claim 7, wherein the metadata comprises information relating to the properties of the one or more digital representations.

9. The method of claim 8, wherein the properties comprise data relating to the origin of the one or more digital representations.

10. The method of claim 1, wherein each of the one or more digital objects are identified by a unique digital object identifier.

11. The method of claim 6 furthering comprising using the one or more digital representations in an interactive game.

12. The method of claim 1 further comprising using the one or more digital representations in a task required within the interactive online environment.

13. The method of claim 1, wherein the interface comprises software.

14. The method of claim 1 further comprising manipulating (1) the one or more digital representations, (2) one or more digital objects, or a combination of (1) and (2).

15. The method of claim 1, wherein the one or more digital representations represent one or more avatars.

16. The method of claim 1, wherein the one or more digital representations is incorporated into an online game.

17. The method of claim 1, wherein the one or more digital representations is traded as currency.

18. The method of claim 16, wherein the one or more digital representations is traded as currency within the online game.

19. The method of claim 1 further comprising generating digital attributes for the one or more digital representations.

20. The method of claim 19, wherein the one or more digital attributes is a color.

21. The method of claim 19, wherein the one or more digital attributes is a virtual personality.

22. The method of claim 19, wherein the one or more digital attributes is a virtual sound.

23. The method of claim 1, wherein the one or more three-dimensional objects comprises a structure that is a replica of (1) one or more digital objects, (2) one or more digital representations, or (3) a combination of (1) and (2).

24. The method of claim 14, wherein the manipulating comprises altering the appearance of (1) the one or more digital representations or (2) one or more digital objects.

25. The method of claim 14, wherein the manipulating comprises providing digital attributes to (1) the one or more digital representations or (2) one or more digital objects.

26. The method of claim 14, wherein the manipulating comprises adding metadata to (1) the one or more digital representations or (2) one or more digital objects.

27. The method of claim 19, wherein one or more digital attributes is an action, skill, talent, or class programmed into the game.

28. The method of claim 19, wherein one or more digital attributes is an item discovered, used, or equipped by the user within the interface.

29. The method of claim 23, wherein the three-dimensional objects are used in analog gameplay.

30. The method of claim 29 further comprising scanning a physical object to create a digital object.

31. The method of claim 24 wherein manipulating the digital representation or digital objects requires identical manipulation and recreation of the physical 3D object.

32. The method of claim 1, wherein the manipulation of the 3D object alters the digital representation.

39. The method of claim 1, wherein the interface is an application on a tablet, Smartphone, or mobile connectivity device.

40. The method of claim 39 further comprising instructions to allow users to exchange data relating to three-dimensional objects or digital objects.

41. The method of claim 17 further comprising allowing a first user to access a printer of a second user to force printing based on the actions of the second user.

42. The method of claim 9, wherein the properties comprise data relating to a translated physical object or where the origin of the one or more digital representations is taken from an actual object.

43. The method of claim 1 further comprising instructions allowing creation of tasks to complete within a game environment depending on the actions of one or more users.

44. The method of claim 43, wherein the tasks are performed using the three-dimensional printer.
